(19) United States
(12) Patent Application Publication
(10) Pub. No.: US 2006/0022567 A1
(43) Pub. Date: Feb. 2, 2006

(54) Electrodeless fluorescent lamps operable in and out of fixture with little change in performance

(75) Inventors: Fred L. Palmer, Danvers, MA (US); Jakob Maya, Brookline, MA (US)

Correspondence Address: William R. McClellan;Wolf, Greenfield & Sacks, P.C., 600 Atlantic Avenue, Boston, MA, 02210, US

(73) Assignee: Matsushita Electric Works Ltd., Osaka (JP)

(21) Appl. No.: 10/900,727

(22) Filed: Jul. 28, 2004

(51) Int. Cl. H01J 1/50; H01J 23/10

(52) U.S. Cl. 313/160; 313/161

(57) ABSTRACT

An electrodeless fluorescent lamp is configured such that the lamp operates at frequencies less than 500 kHz both in and out of a fixture with little change in performance. The lamp employs relatively high rare gas pressure, relatively small reentrant cavity diameter and a relatively short magnetic core to achieve good performance in the fixture.

### FIELD OF THE INVENTION

This invention relates to electrodeless fluorescent lamps and, more particularly, to electrodeless fluorescent lamps that can operate both in and out of a fixture with little change in performance.

### BACKGROUND OF THE INVENTION

Electrodeless fluorescent lamps are very useful light sources because they are efficient and exceptionally long-lived. They also have excellent color characteristics and can be started quickly and restarted without difficulty or damage to the lamp. Electrodeless fluorescent lamps typically include a phosphor-coated lamp envelope and have a reentrant cavity. The lamp envelope contains mercury vapor and a rare gas. The reentrant cavity contains an excitation coil around one or more ferrite cores such that the lamp can be energized by a radio frequency current through the excitation coil.

The use of electrodeless fluorescent lamps has been limited, partly because of their reduced performance in fixtures. Fixtures affect lamp performance in two ways. They change the impedance of the lamp and they decrease the efficiency with which electric power is coupled to the lamp. At higher frequencies, approximately 2 MHz and up, the coupling efficiency may not be a significant problem, and lamps can be designed with shorted turns or rings that improve the stability of the impedance, even though they substantially decrease coupling efficiency. At lower frequencies however, adequate coupling efficiency is much harder to achieve, especially in small lamps and small fixtures. Poorly coupled lamps are not just inefficient. At coupling efficiencies below about 85%, the lamps behave erratically, and below about 70% coupling efficiency, the lamps become unstable and do not function at all. Since coupling efficiency is somewhat worse at a temperature of 10 to 20 degrees below room temperature, it is highly desirable to design lamps with a few percent better than 85% coupling efficiency at room temperature. The requirements of adequate coupling and an input impedance that is stable enough to operate on existing ballasts leaves a narrow range of usable designs for small, low frequency lamps operating in fixtures.

Electrodeless fluorescent lamps have been disclosed by way of example in U.S. Pat. No. 3,521,120 issued Jul. 21, 1970 to Anderson; U.S. Pat. No. 4,536,675 issued Aug. 20, 1985 to Postma; and U.S. Pat. No. 4,704,562 issued Nov. 3, 1987 to Postma, et al. Most of the literature on electrodeless fluorescent lamp fixtures deals with capacitive coupling between the lamp and the fixture. Techniques to mitigate this effect have been described. U.S. Pat. No. 5,783,912 issued Jul. 21, 1998 to Cocoma, et al. describes a transparent coating on the bulb and a wire that carries the current back to the ballast. Various shielding structures and coil geometries are disclosed in U.S. Pat. No. 5,325,018 issued Jun. 28, 1994 to El-Hamamsy; U.S. Pat. No. 5,621,266 issued Apr. 15, 1997 to Popov et al.; U.S. Pat. No. 5,726,523 issued Mar. 10, 1998 to Popov et al.; U.S. Pat. No. 6,081,070 issued Jun. 27, 2000 to Popov et al.; and U.S. Pat. No. 6,249,090 issued Jun. 19, 2001 to Popov et al. U.S. Pat. No. 5,461,284 issued Oct. 24, 1995 to Roberts, et al. discloses a virtual fixture for reducing electromagnetic interaction between an electrodeless lamp and a metallic fixture.

All of the known electrodeless fluorescent lamps have had one or more drawbacks and disadvantages. Accordingly, there is a considerable need for electrodeless fluorescent lamps that operate at frequencies of less than about 500 kHz both in and out of a fixture with little change in performance.

### SUMMARY OF THE INVENTION

According to a first aspect of the invention, an electrodeless lamp comprises a bulbous, light-transmissive lamp envelope having a reentrant cavity, lamp envelope being filled with a metal vapor and a rare gas, and having a phosphor coating on an interior surface for generation of visible light, the rare gas having a pressure greater than 25 torr/D, where D is the diameter of the lamp envelope in millimeters, and an excitation coil located in the reentrant cavity and disposed around a magnetic core, the excitation coil configured for operation at a frequency of less than 500 kHz.

According to a second aspect of the invention, an electrodeless lamp comprises a bulbous, light-transmissive lamp envelope having a reentrant cavity, the lamp envelope being filled with a metal vapor and a rare gas, and having a phosphor coating on an interior surface for generation of visible light, the reentrant cavity having a diameter of less than 0.3 times the diameter of the lamp envelope, and an excitation coil located in the reentrant cavity and disposed around a magnetic core, the excitation coil configured for operation at a frequency of less than 500 kHz.

According to a third aspect of the invention, an electrodeless lamp comprises a bulbous, light-transmissive lamp envelope having a reentrant cavity, the lamp envelope being filled with a metal vapor and a rare gas, and having a phosphor coating on an interior surface for generation of visible light, and an excitation coil located in the reentrant cavity and disposed around a magnetic core, the excitation coil configured for operation at a frequency of less than 500 kHz. The magnetic core has a length less than 0.65 times the diameter of the lamp envelope.

According to a fourth aspect of the invention, a lamp assembly is provided. The lamp assembly comprises an electrodeless lamp and a conducting fixture. The electrodeless lamp comprises a bulbous, light-transmissive lamp envelope having a reentrant cavity, the lamp envelope being filled with a metal vapor and a rare gas, and having a phosphor coating on an interior surface for generation of light, and an excitation coil located in the reentrant cavity and disposed around a magnetic core, the excitation coil configured for operation at a frequency of less than 500 kHz. The conducting fixture is configured for mounting the electrodeless lamp and has a diameter at an axial location of maximum lamp envelope diameter that is in a range of about 1.25 to 2.0 times the maximum lamp envelope diameter.

In some embodiments, the rare gas has a pressure greater than 25 torr/D, where D is the diameter of the lamp envelope in millimeters. In embodiments where the diameter of the lamp envelope is less than 100 millimeters, the rare gas may be krypton at a pressure greater than 0.25 torr. In further embodiments, the reentrant cavity may have a diameter less than 0.3 times the diameter of the lamp envelope. In further embodiments, the magnetic core may have a length less than 0.65 times the diameter of the lamp envelope. These features may be utilized separately or in any combination.

### BRIEF DESCRIPTION OF THE DRAWINGS

For a better understanding of the present invention, reference is made to the accompanying drawings, which are incorporated herein by reference and in which:

FIG. 1 is a schematic cross-sectional view of a lamp assembly including an electrodeless fluorescent lamp and a fixture in accordance with a first embodiment of the invention;

FIG. 2 is a schematic cross-sectional view of a lamp assembly including an electrodeless fluorescent lamp and a fixture in accordance with a second embodiment of the invention;

FIG. 3 is a schematic cross-sectional view of an electrodeless fluorescent lamp envelope utilized in the lamp assemblies of FIGS. 1 and 2; and

FIG. 4 is a schematic cross-sectional view of a coupler utilized in the lamp assemblies of FIGS. 1 and 2.

### DETAILED DESCRIPTION

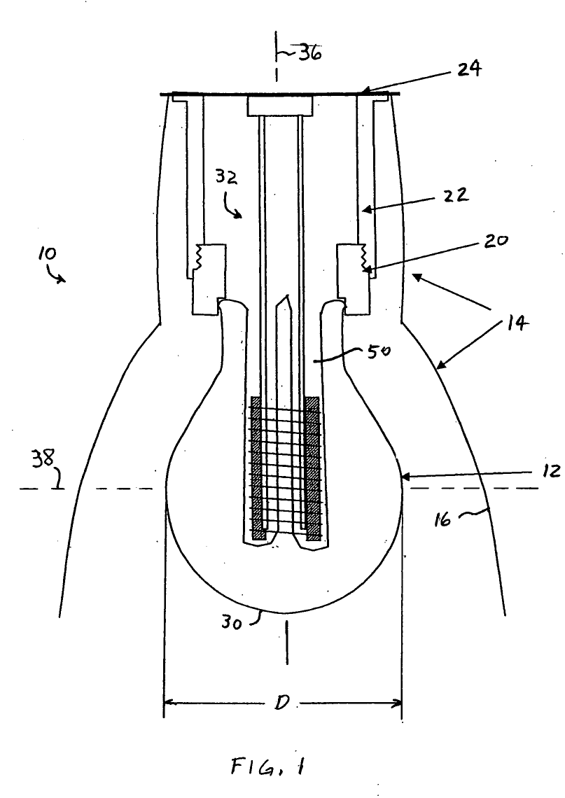

A simplified cross-sectional diagram of a lamp assembly in accordance with a first embodiment of the invention is shown in FIG. 1. A lamp assembly 10 includes an electrodeless lamp 12 and a fixture 14 for mounting of lamp 12. Fixture 14 may be stamped from a single piece of aluminum and polished to high reflectivity on an inside surface 16. Electrodeless lamp 12 is positioned in fixture 14 such that much of the light generated by lamp 12 is reflected out of fixture 14. In the embodiment of FIG. 1, fixture 14 has a variable diameter as a function of axial position. A lamp base 20 is attached permanently to lamp 12. Lamp base 20 screws into a stand 22 that is attached to a fixture base 24. Electrodeless lamp 12 includes a lamp envelope 30 and a coupler 32.

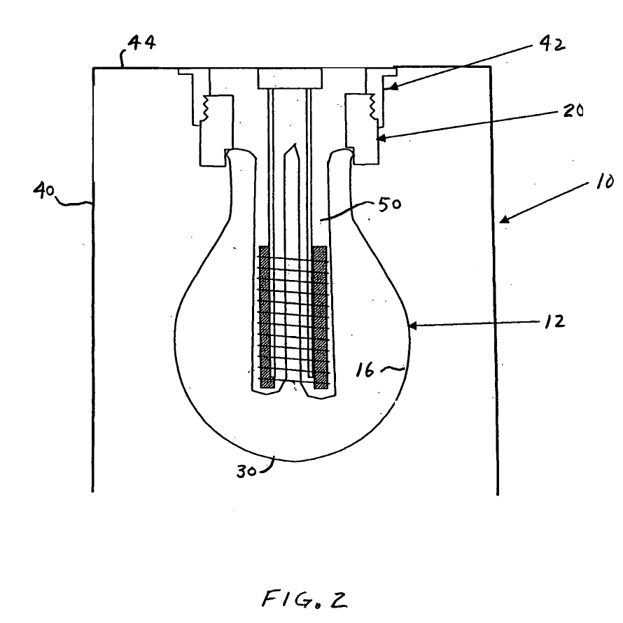

A lamp assembly in accordance with a second embodiment of the invention is shown in FIG. 2. Like elements in FIGS. 1 and 2 have the same reference numerals. Fixture 40 has a cylindrical shape, such as used in a standard track light fixture. A stand 42 may have a relatively short axial length in the embodiment of FIG. 2.

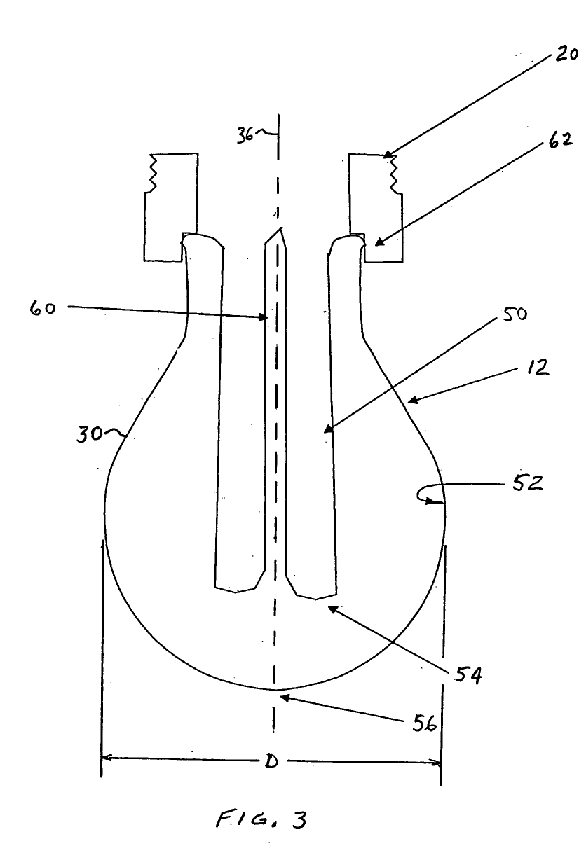

Lamp envelope 30 is shown in FIG. 3. Lamp envelope 30 may be a light-transmissive material, such as glass, having a bulbous shape. Lamp envelope 30 is filled with mercury vapor and a rare gas, such as krypton, argon and mixtures of krypton and argon. Lamp envelope 30 includes a reentrant cavity 50 which houses coupler 32. An inside surface 52 of lamp envelope 30 is coated with a phosphor that converts ultraviolet radiation into visible light. Suitable phosphor mixes are commercially available. A phosphor thickness of 3 to 5 milligrams per square centimeter is suitable for the outside portion of the lamp envelope, but a phosphor coating approximately three times thicker is preferable for the cavity portion. An inside surface of cavity 50 (the surface exposed to air) may be painted white in order to reflect light. The inside surface of the lamp envelope and the outside surface of reentrant cavity 50 may be etched or sandblasted to improve phosphor adhesion. The optimum temperature at which the lamp operates can be adjusted by varying the distance between end 54 of cavity 50 and dome 56 of lamp envelope 30. For 30-watt operation near room temperature, this distance should be about one fourth the diameter of the bulb. An exhaust tube 60 in the center of cavity 50 is used to remove air from the lamp envelope and to add rare gas and mercury, after which exhaust tube 60 is melted shut. Lamp base 20 is permanently attached to lamp envelope 30 by high temperature adhesive at an interface 62 between lamp envelope 30 and lamp base 20.

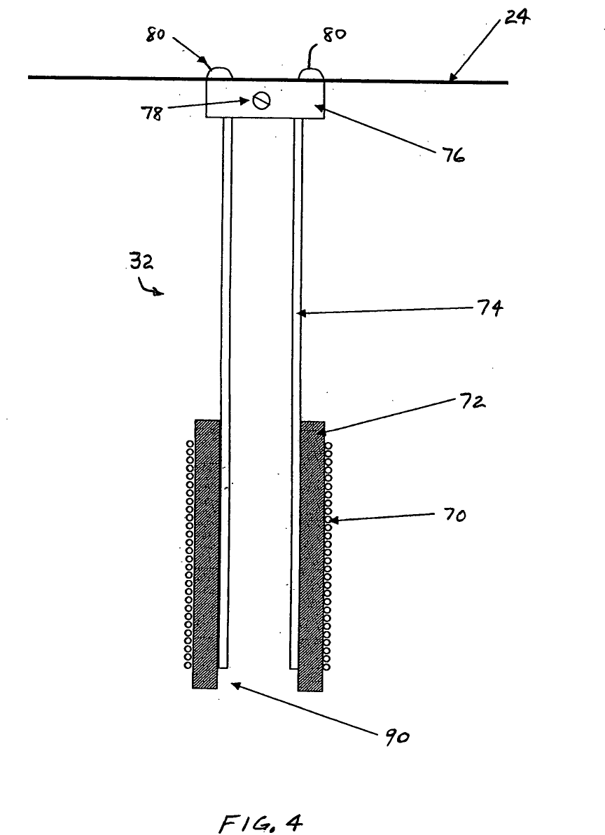

Coupler 32 is shown in FIG. 4. The coupler includes an excitation coil 70, a magnetic core 72 and a thermally conductive tube 74 which helps to remove heat from coil 70 and magnetic core 72. Magnetic core 72 may include one or more ferrite elements, and tube 74 may be a copper or aluminum tube. Tube 74 can be attached to fixture base 24 by any arrangement that provides good thermal contact. The embodiment of FIG. 4 utilizes a bushing 76 and a set screw 78. Bushing 76 attaches to fixture base 24 by screws 80. Thermally conductive tube 74 is in close contact with the inside surface of magnetic element 72, but magnetic element 72 may extend a few millimeters (mm) past the end of tube 74, as indicated at 90. The magnetic element 72 and the tube 74 are cemented together with an adhesive, such as silicone, which can withstand temperatures of 200° C. or more.

For low frequency operation, excitation coil 70 may be made of Litz wire. Preferably, the wire should have more than 50 strands, with each strand being less than 0.1 mm in diameter. Other wires can be used with some decrease in coupling efficiency. The excitation coil 70 may be a close-wound single layer that covers most of magnetic core 72, although turns of wire within a few millimeters of the ends of magnetic core 72 are less effective and may be omitted. Excitation coil 70 and magnetic core 72 are configured for operation at a frequency of 500 kHz or less, and preferably in a range of about 100 to 200 kHz.

In operation, current of a few amperes at a frequency of 500 kHz or less is applied to excitation coil 70 which, along with magnetic core 72 produces an oscillating magnetic field that causes an electric field which energizes the lamp. The electrical energy supports a low pressure discharge which emits ultraviolet radiation. The phosphor coating on the inside surface of lamp envelope 30 converts the ultraviolet radiation into visible light.

The rare gas pressure and the dimensions of the reentrant cavity 50 and the magnetic core 72 depend on the overall size of the lamp, power level and the operating frequency. For a preferred lamp having a diameter of 80 mm operating at 100 to 200 kHz, a krypton pressure of 0.4 torr, a cavity 50 outer diameter of 22 mm and a core 72 length of 50 mm gives approximately 2500 lumens with 30 watts of input power outside the fixture and only about 1.5 percent less inside a cylindrical fixture having a diameter of 115 mm as shown in FIG. 2.

The performance of the preferred lamp described above is compared in Table 1 below with the performance of more conventional lamps. The first row of Table 1 shows the preferred lamp and coupler, with other configurations in the following rows. The first four columns describe the lamps, and the fifth column describes the inductance change when the lamps are inserted in the 115 mm diameter cylindrical fixture. The last column gives the coupling efficiency measured after a lamp has been running for at least 45 minutes at room temperature.

TABLE 1
Change of performance of lamps when
surrounded by metal fixture:

| | Cavity | | Ferrite | | Coupling |
|---|---|---|---|---|---|
| | O.D. | | length | Inductance | efficiency in |
| Lamp | (mm) | Gas (torr) | (mm) | change | fixture |
| #15 | 22 | 0.4 Kr. | 50 | −6% | 89% |
| #13 | 25 | 0.5 Ar. | 50 | −6% | 79% |
| #15 | 22 | 0.4 Kr. | 70 | −10% | 91% |
| #14 | 25 | .6 Ar. | 50 | — | 85% no fixture |
| #14 | 25 | .6 Ar. | 70 | — | 90% no fixture |

Although most lamp designs that work well outside a fixture perform poorly when placed inside a fixture, several variations are usable. In particular, modest changes in overall size, up to about 15%, give similar performance if the gas pressure is modified to keep the product of the gas pressure and lamp diameter about the same.

For an 80 mm diameter lamp, krypton pressures as low as 0.15 torr perform well outside a fixture, but inside the fixture, any pressure below about 0.3 torr is likely to suffer from inadequate coupling. Substitution of argon for krypton is not particularly attractive. Much higher argon pressures, about 1 torr, are needed to achieve the desired coupling efficiency, at which point the light output is low.

In order to achieve adequate coupling both in and out of the fixture, a rare gas pressure greater than 25 torr/D may be utilized, where D is a dimensionless quantity that corresponds to the diameter of the lamp envelope in millimeters. As shown in FIG. 3, the lamp envelope diameter D is the maximum lamp envelope diameter along a lamp axis 36. For a lamp envelope having a diameter of 100 millimeters, the rare gas pressure may be greater than 0.25 torr. In cases where the rare gas is pure krypton, the pressure may be greater than 25 torr/D. In cases where the rare gas is pure argon, the pressure may be greater than 50 torr/D. In cases where the rare gas is a mixture of krypton and argon, the sum of the krypton pressure and one half the argon pressure may be greater than 25 torr/D. A higher argon pressure is specified to achieve the desired coupling efficiency.

Performance is quite sensitive to cavity diameter. Inside the fixture, increasing the cavity diameter reduces the coupling efficiency in a fixture by about one percent per millimeter, although 25 mm cavities perform as well as 22 mm cavities outside fixtures. Variations in magnetic core length have particularly unexpected effects. In a typical lamp, such as #14 in Table 1, a 7 cm long ferrite core provides a coupling efficiency that is 5% better than a 5 cm ferrite core. In the preferred lamp and fixture, however, this improvement decreases to less than 2%, and the light output is slightly better. More importantly, the lamp with a long ferrite core exhibits almost twice the change in impedance when the lamp is placed in a fixture. Few, if any available ballasts can tolerate such a large impedance change.

As a result, adequate coupling, both in and out of the fixture may be achieved with a reentrant cavity having a diameter that is less than 0.3 times the diameter of the lamp envelope. Typically, the reentrant cavity has a diameter of less than 25 millimeters. In addition, the magnetic core may have a length less than 0.65 times the diameter of the lamp envelope. The magnetic core typically has a length less than 65 millimeters. Preferably, the excitation coil has a length of at least two thirds the length of the magnetic core.

Using the lamp parameters described above, electrodeless lamps can operate in and out of a conducting fixture with little change in performance. The conducting fixture may have a diameter at the axial location of maximum lamp envelope diameter that is in a range of about 1.25 to 2.0 times the maximum lamp envelope diameter. In the case of a fixture having a diameter that varies along its axis, the electrodeless lamp may be positioned within the fixture to achieve the above relationship between lamp envelope diameter and fixture diameter. As shown in FIG. 1, lamp envelope 30 has a maximum diameter along lamp axis 36 in a plane 38. Electrodeless lamp 12 is positioned in fixture 14 such that fixture 14 has a diameter in plane 38 that is in a range of about 1.25 to 2.0 times the maximum lamp envelope diameter.

Having described several embodiments and an example of the invention in detail, various modifications and improvements will readily occur to those skilled in the art. Such modifications and improvements are intended to be within the spirit and the scope of the invention. Furthermore, those skilled in the art would readily appreciate that all parameters listed herein are meant to be exemplary and that actual parameters will depend upon the specific application for which the system of the present invention is used. Accordingly, the foregoing description is by way of example only and is not intended as limiting. The invention is limited only as defined by the following claims and their equivalents.

What is claimed is:

1. An electrodeless lamp comprising:
a bulbous, light-transmissive lamp envelope having a reentrant cavity, the lamp envelope being filled with a metal vapor and a rare gas, and having a phosphor coating on an interior surface for generation of visible light, the rare gas having a pressure greater than 25 torr/D, where D is the diameter of the lamp envelope in millimeters; and
an excitation coil located in the reentrant cavity and disposed around a magnetic core, the excitation coil configured for operation at a frequency of less than 500 kHz.

2. An electrodeless lamp as defined in claim 1, wherein the rare gas comprises krypton at a pressure greater than 25 torr/D.

3. An electrodeless lamp as defined in claim 2, wherein the diameter of the lamp envelope is less than 100 millimeters.

4. An electrodeless lamp as defined in claim 2, wherein the krypton pressure is greater than 0.25 torr.

5. An electrodeless lamp as defined in claim 1, wherein the rare gas comprises argon at a pressure greater than 50 torr/D.

6. An electrodeless lamp as defined in claim 1, wherein the rare gas comprises a mixture of krypton and argon and wherein the sum of the krypton pressure and one half the argon pressure is greater than 25 torr/D.

7. An electrodeless lamp comprising:
A bulbous, light-transmissive lamp envelope having a reentrant cavity, the lamp envelope being filled with a metal vapor and a rare gas, and having a phosphor coating on an interior surface for generation of visible light, the reentrant cavity having a diameter less than 0.3 times the diameter of the lamp envelope; and
an excitation coil located in the reentrant cavity and disposed around a magnetic core, the excitation coil configured for operation at a frequency of less than 500 kHz.

8. An electrodeless lamp as defined in claim 7, wherein the reentrant cavity has a diameter less than 25 mm.

9. An electrodeless lamp comprising:
a bulbous, light-transmissive lamp envelope having a reentrant cavity, the lamp envelope being filled with a metal vapor and a rare gas, and having a phosphor coating on an interior surface for generation of visible light; and
an excitation coil located in the reentrant cavity and disposed around a magnetic core, the excitation coil configured for operation at a frequency of less than 500 kHz, the magnetic core having a length less than 0.65 times the diameter of the lamp envelope.

10. An electrodeless lamp as defined in claim 9, wherein the magnetic core comprises a ferrite material.

11. An electrodeless lamp as defined in claim 9, wherein the magnetic core has a length less than 65 millimeters.

12. An electrodeless lamp as defined in claim 9, wherein the excitation coil has a length of at least two thirds the length of the magnetic core.

13. An electrodeless lamp as defined in claim 12, wherein the excitation coil comprises Litz wire having 7 to 120 strands.

14. An electrodeless lamp as defined in claim 9, wherein the rare gas comprises krypton having a pressure greater than 25 torr/D, where D is the diameter of the lamp envelope in millimeters.

15. An electrodeless lamp as defined in claim 14, wherein the reentrant cavity has a diameter less than 0.3 times the diameter of the lamp envelope.

16. An electrodeless lamp as defined in claim 14, wherein the rare gas comprises krypton having a pressure greater than 0.25 torr.

17. An electrodeless lamp as defined in claim 14, wherein the diameter of the lamp envelope is less than 100 millimeters.

18. A lamp assembly comprising:
an electrodeless lamp comprising a bulbous, light-transmissive lamp envelope having a reentrant cavity, the lamp envelope being filled with a metal vapor and a rare gas, and having a phosphor coating on an interior surface for generation of light, and an excitation coil located in the reentrant cavity and disposed around a magnetic core, the excitation coil configured for operation at a frequency of less than 500 kHz; and
a conducting fixture configured for mounting of the electrodeless lamp, the conducting fixture having a diameter at an axial location of maximum lamp envelope diameter that is in a range of about 1.25 to 2.0 times the maximum lamp envelope diameter.

19. A lamp assembly as defined in claim 18, wherein the rare gas has a pressure greater than 25 torr/D, where D is the diameter of the lamp envelope in millimeters.

20. A lamp assembly as defined in claim 18, wherein the lamp envelope has a diameter less than 100 millimeters, wherein the rare gas comprises krypton having a pressure greater than 0.25 torr, wherein the reentrant cavity has a diameter less than 25 millimeters and wherein the magnetic core has a length less than 65 millimeters.

21. A lamp assembly comprising:
an electrodeless lamp comprising a bulbous, light-transmissive lamp envelope having a reentrant cavity, the lamp envelope being filled with a metal vapor and a rare gas, and having a phosphor coating on an interior surface for generation of light, the rare gas having a pressure greater than 25 torr/D, where D is the diameter of the lamp envelope in millimeters, and an excitation coil located in the reentrant cavity and disposed around a magnetic core, the excitation coil configured for operation at a frequency of less than 500 kHz; and
a conducting fixture configured for mounting of the electrodeless lamp, the conducting fixture having a diameter at an axial location of maximum lamp envelope diameter that is in a range of about 1.25 to 2.0 times the maximum lamp envelope diameter.

22. A lamp assembly as defined in claim 21, wherein the rare gas comprises krypton at a pressure greater than 25 torr/D.

23. A lamp assembly as defined in claim 21, wherein the rare gas comprises argon at a pressure greater than 50 torr/D.

24. A lamp assembly as defined in claim 21, wherein the rare gas comprises a mixture of krypton and argon and wherein the sum of the krypton pressure and one half the argon pressure is greater than 25 torr/D.

25. A lamp assembly comprising:
an electrodeless lamp comprising a bulbous, light-transmissive lamp envelope having a reentrant cavity, the lamp envelope being filled with a metal vapor and a rare gas, and having a phosphor coating on an interior surface for generation of light, the reentrant cavity having a diameter less than 0.3 times the diameter of the lamp envelope, and an excitation coil located in the reentrant cavity and disposed around a magnetic core, the excitation coil configured for operation at a frequency of less than 500 kHz; and
a conducting fixture configured for mounting of the electrodeless lamp, the conducting fixture having a diameter at an axial location of maximum lamp envelope diameter that is in a range of about 1.25 to 2.0 times the maximum lamp envelope diameter.

26. A lamp assembly as defined in claim 25, wherein the reentrant cavity has a diameter less than 25 millimeters.

27. A lamp assembly comprising:
an electrodeless lamp comprising a bulbous, light-transmissive lamp envelope having a reentrant cavity, the lamp envelope being filled with a metal vapor and a rare gas, and having a phosphor coating on an interior surface for generation of light, and an excitation coil located in the reentrant cavity and disposed around a magnetic core, the excitation coil configured for operation at a frequency of less than 500 kHz, the magnetic core having a length less than 0.65 times the diameter of the lamp envelope; and
a conducting fixture configured for mounting of the electrodeless lamp, the conducting fixture having a diameter at an axial location of maximum lamp envelope diameter that is in a range of about 1.25 to 2.0 times the maximum lamp envelope diameter.

28. A lamp assembly as defined in claim 27, wherein the magnetic core comprises a ferrite material.

29. A lamp assembly as defined in claim 27, wherein the magnetic core has a length less than 65 millimeters.

30. A lamp assembly as defined in claim 27, wherein the excitation coil has a length of at least two thirds the length of the magnetic core.
